(19) United States
(12) Patent Application Publication
(10) Pub. No.: US 2011/0138311 A1
(43) Pub. Date: Jun. 9, 2011

(54) Display Of Respiratory Data On A Ventilator Graphical User Interface

(75) Inventor: Marc E. Palmer, Trabuco Canyon, CA (US)

(73) Assignee: Nellcor Puritan Bennett LLC, Boulder (US)

(21) Appl. No.: 12/631,712

(22) Filed: Dec. 4, 2009

(51) Int. Cl. G06F 3/048

(52) U.S. Cl. 715/771; 715/784

(57) ABSTRACT

This disclosure describes improved systems and methods for displaying respiratory data to a clinician in a ventilatory system. Specifically, embodiments enable a clinician to visualize data from a variety of historical graphical representations associated with a selected historical time. That is, a cursor or other visual indicator may be provided that identifies the selected historical time on each of a plurality of historical graphical representations of respiratory data. Further, specific data values associated with the historical time and corresponding to a data point on each of the plurality of historical graphical representations may be highlighted for optimal display and comparison.

### RELATED APPLICATIONS

This application is related to co-owned U.S. patent application Ser. No. ______, entitled “Visual Indication of Settings Changes on a Respiratory Ventilator Graphical User Interface”; U.S. patent application Ser. No. ______, entitled “Display and Access to Settings on a Respiratory Ventilator Graphical User Interface”; U.S. patent application Ser. No. ______, entitled “Visual Indication of Alarms on a Ventilator Graphical User Interface”; and U.S. patent application Ser. No. ______, entitled “Quick Initiation of Respiratory Support via a Ventilator User Interface”; all filed on ______, the entire disclosures of all of which are hereby incorporated herein by reference.

### INTRODUCTION

A ventilator is a device that mechanically helps patients breathe by replacing some or all of the muscular effort required to inflate and deflate the lungs. During respiration, the ventilator may be configured to present various graphs, charts, and other displays indicative of the physical condition of the patient and the respiratory treatment provided. The ventilatory displays may be further designed to present relevant clinical information to a practitioner in an efficient and orderly manner. However, ambiguities may arise where multiple graphs and charts are displayed to the clinician at the same time.

Specifically, many of the graphs, charts, and other displays relied on by clinicians for useful information regarding the patient and the prescribed respiratory treatment may not be easily compared. For instance, some graphs and charts may be displayed based on one variable or scale, while other graphs and charts may be displayed based on another variable or scale.

### Display of Respiratory Data on a Ventilator Graphical User Interface

This disclosure describes improved systems and methods for displaying respiratory data to a clinician in a ventilatory system. Respiratory data may be displayed by any number of suitable means, for example, via appropriate graphs, diagrams, charts, waveforms, and other graphic displays. Additionally, a ventilator may display many different types of data and data correlations at one time. These multiple graphic displays may present data which may or may not incorporate temporal correlations and, when temporal correlations are presented, the temporal correlations may or may not be based on the same temporal unit or scale.

Embodiments described herein seek to provide methods and systems for correlating multiple graphs and charts according to a common temporal element. Specifically, embodiments described herein may provide a cursor, or other graphical or visual indicator, that signifies a data position on each of a plurality of graphs that corresponds to the common temporal element. Additionally, embodiments may highlight specific data values, or coordinates, associated with the common temporal element on each of the plurality of graphs. As such, embodiments enable a clinician to visualize and compare the specific data corresponding to a common temporal element on a plurality of graphs. As described herein, the common temporal element may be referred to as a selected historical time and/or a scroll time.

Specifically, embodiments may recite methods implemented by a ventilator for displaying respiratory data on a graphical user interface. The methods may comprise archiving a plurality of graphical representations of the respiratory data in sequential order during a time period. Thereafter, a selection of a historical time within the time period may be received. The methods may then determine appropriate graphical representations of the archived plurality of graphical representations corresponding to the selected historical time. The methods may further determine appropriate positions on the appropriate graphical representations corresponding to the selected historical time. Upon these determinations, a visual indication may be displayed at each appropriate position on each appropriate graphical representation corresponding to the selected historical time.

These and various other features as well as advantages which characterize the systems and methods described herein will be apparent from a reading of the following detailed description and a review of the associated drawings. Additional features are set forth in the description which follows, and in part will be apparent from the description, or may be learned by practice of the technology. The benefits and features of the technology will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The following drawing figures, which form a part of this application, are illustrative of described technology and are not meant to limit the scope of the invention as claimed in any manner, which scope shall be based on the claims appended hereto.

FIG. 1 is a diagram illustrating an embodiment of an exemplary ventilator connected to a human patient.

FIG. 2 is a block-diagram illustrating an embodiment of a ventilatory system having a graphical user interface for displaying respiratory data.

FIG. 3 is an illustration of an embodiment of a graphical user interface for displaying a plurality of historical graphical representations of respiratory data.

FIG. 4 is an illustration of an embodiment of a graphical user interface for displaying historical graphical representations for a single type of respiratory data.

FIG. 5 is a flow chart illustrating an embodiment of a method for displaying cursors in appropriate positions on a plurality of historical graphical representations of respiratory data.

### DETAILED DESCRIPTION

Although the techniques introduced above and discussed in detail below may be implemented for a variety of medical devices, the present disclosure will discuss the implementation of these techniques for use in a mechanical ventilator system. The reader will understand that the technology described in the context of a ventilator system could be adapted for use with other therapeutic equipment having graphical user interfaces for displaying data.

This disclosure describes improved systems and methods for displaying respiratory data to a clinician in a ventilatory system. Specifically, embodiments enable a clinician to visualize data from a variety of historical graphical representations associated with a selected historical time. That is, a cursor or other visual indicator may be provided that identifies a position on each of a plurality of historical graphical representations of respiratory data corresponding to the selected historical time. Further, specific data coordinates associated with the selected historical time and corresponding to a data point on each of the plurality of historical graphical representations may be highlighted for optimal display and comparison.

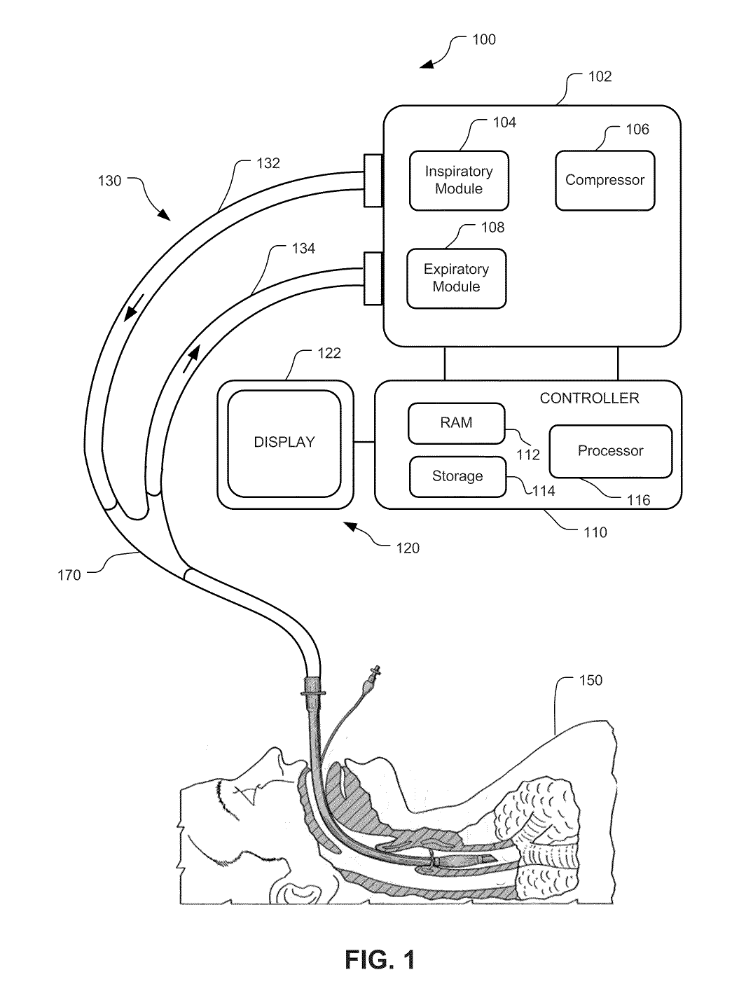

FIG. 1 illustrates an embodiment of a ventilator 100 connected to a human patient 150. Ventilator 100 includes a pneumatic system 102 (also referred to as a pressure generating system 102) for circulating breathing gases to and from patient 150 via the ventilation tubing system 130, which couples the patient to the pneumatic system via an invasive patient interface.

Ventilation tubing system 130 may be a two-limb (shown) or a one-limb circuit for carrying gas to and from the patient 150. In a two-limb embodiment as shown, a fitting, typically referred to as a “wye-fitting” 170, may be provided to couple the patient interface to an inspiratory limb 132 and an expiratory limb 134 of the ventilation tubing system 130.

Pneumatic system 102 may be configured in a variety of ways. In the present example, system 102 includes an expiratory module 108 coupled with the expiratory limb 134 and an inspiratory module 104 coupled with the inspiratory limb 132. Compressor 106 or other source(s) of pressurized gases (e.g., air, oxygen, and/or helium) is coupled with inspiratory module 104 to provide a gas source for ventilatory support via inspiratory limb 132.

The pneumatic system may include a variety of other components, including sources for pressurized air and/or oxygen, mixing modules, valves, sensors, tubing, accumulators, filters, etc. Controller 110 is operatively coupled with pneumatic system 102, signal measurement and acquisition systems, and an operator interface 120 that may enable an operator to interact with the ventilator 100 (e.g., change ventilator settings, select operational modes, view monitored parameters, etc.). Controller 110 may include memory 112, one or more processors 116, storage 114, and/or other components of the type commonly found in command and control computing devices.

The memory 112 is computer-readable storage media that stores software that is executed by the processor 116 and which controls the operation of the ventilator 100. In an embodiment, the memory 112 includes one or more solid-state storage devices such as flash memory chips. In an alternative embodiment, the memory 112 may be mass storage connected to the processor 116 through a mass storage controller (not shown) and a communications bus (not shown). Although the description of computer-readable media contained herein refers to a solid-state storage, it should be appreciated by those skilled in the art that computer-readable storage media can be any available media that can be accessed by the processor 116. Computer-readable storage media includes volatile and non-volatile, removable and non-removable media implemented in any method or technology for storage of information such as computer-readable instructions, data structures, program modules or other data. Computer-readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

As described in more detail below, controller 110 may monitor pneumatic system 102 in order to evaluate the condition of the patient and to ensure proper functioning of the ventilator. The specific monitoring may be based on inputs received from pneumatic system 102 and sensors, operator interface 120, and/or other components of the ventilator. In the depicted example, operator interface includes a display 122 that is touch-sensitive, enabling the display to serve both as an input and output device.

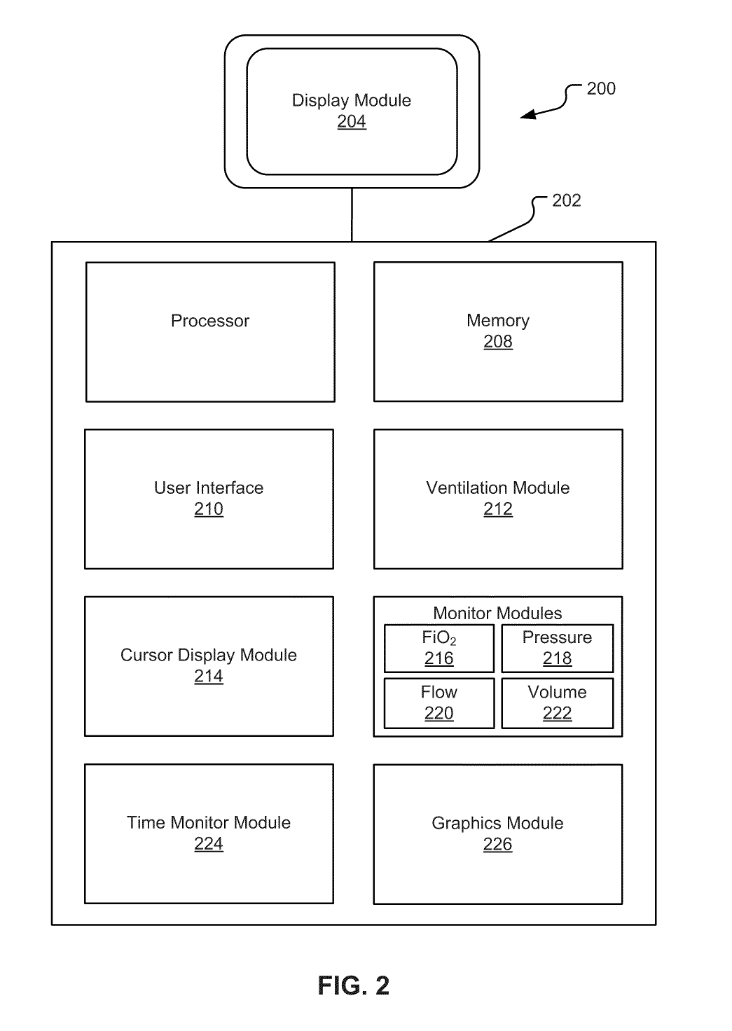

FIG. 2 is a block-diagram illustrating an embodiment of a ventilatory system 200 having a graphical user interface for displaying respiratory data.

The ventilator 202 includes a display module 204, memory 208, one or more processors 206, user interface 210, and ventilation module 212. Memory 208 is defined as described above for memory 112. Similarly, the one or more processors 206 are defined as described above for the one or more processors 116. Processors 206 may further be configured with a clock whereby elapsed time may be monitored by the system 200. Alternatively, a time monitor module 224 may be provided for monitoring time and associating a temporal element with the various data collected by monitoring modules 216-222.

Ventilation module 212 may oversee ventilation as delivered to a patient according to the ventilatory settings prescribed for the patient. For example, ventilation module 212 may deliver pressure and/or volume into a ventilatory circuit (depending on whether the ventilator is configured for pressure or volume controlled delivery), and thereby into a patient's lungs, by any suitable method, either currently known or disclosed in the future.

The display module 204 presents various input screens to a clinician, including but not limited to one or more graphics display screens, as will be described further herein, for receiving clinician input and for displaying useful clinical data to the clinician. The display module 204 is further configured to communicate with user interface 210. The display module 204 may provide various windows and elements to the clinician via a graphical user interface (GUI) for input and interface command operations. Thus, user interface 210 may accept commands and input through display module 204. Display module 204 may also provide useful information in the form of various respiratory data regarding the physical condition of a patient and/or the prescribed respiratory treatment. The useful information may be derived by the ventilator 202, based on data gathered from the various monitoring modules 216-222, and the useful information may be displayed to the clinician in the form of graphs, wave representations, pie graphs, or other suitable forms of graphic display. Display module 204 may further be an interactive display, whereby the clinician may both receive and communicate information to the ventilator 202, as by a touch-activated display screen. Alternatively, user interface 210 may provide other suitable means of communication with the ventilator 202, for instance by a keyboard or other suitable interactive device.

One or more graphics display screens provided by display module 204 may each display one or more graphic representations of respiratory data, for example, pressure waveforms, flow waveforms, pressure-volume loops, etc., as described above. However, each of the one or more graphic representations may be presented with different scales and variables. For instance, a volume waveform may depict tidal volume, i.e., the total volume of air inhaled and exhaled for one respiratory cycle, over time. A pressure waveform may depict circuit pressure, as measured or derived, for each inspiration and expiration over time. Alternatively, a pressure-volume loop may be generated for each breath, inspiration represented as a positive curve and expiration represented as a negative curve completing a single loop. A pressure-volume loop, then, depicted as volume over pressure, does not directly display a temporal element. Thus, a plurality of various graphical representations may be provided, each graphical representation communicating different useful information to the clinician. However, sometimes it may be useful for the clinician to compare the respiratory data displayed in each of the different graphical representations according to a common element, for instance a common temporal element.

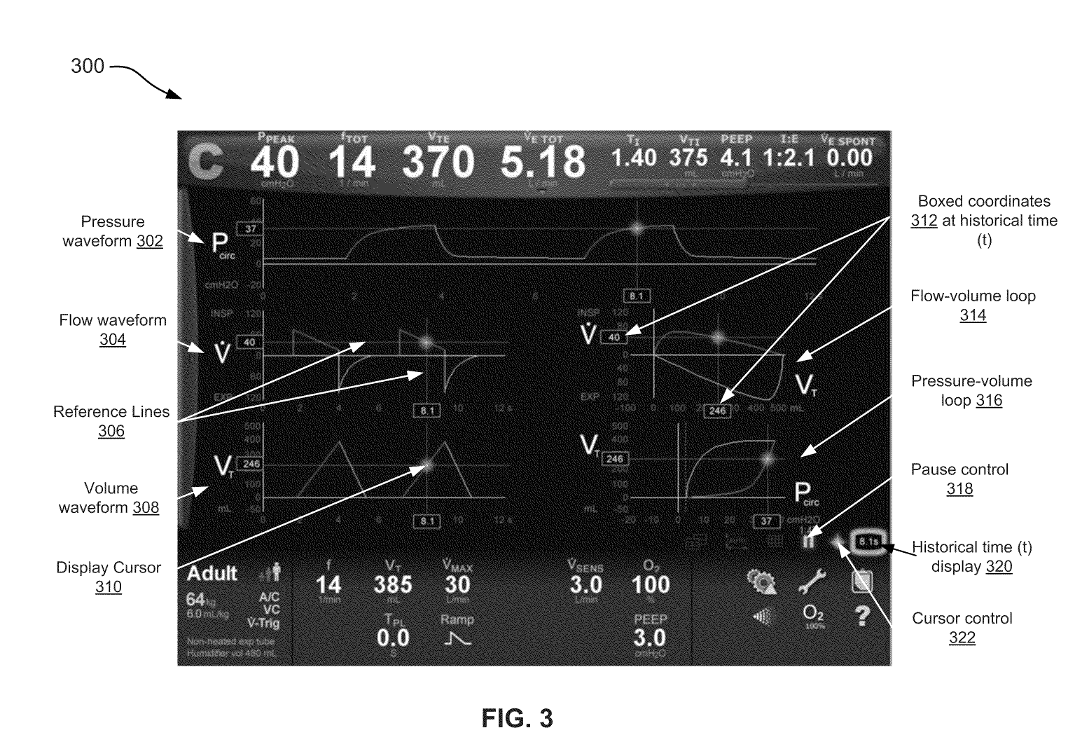

According to one embodiment, as illustrated in FIG. 3, a plurality of graphical representations of respiratory data may be provided in real-time to a clinician on display module 204. To initiate a cursor mode for visualizing data corresponding to a common temporal element on a plurality of graphical representations, a clinician may interact with the display module 204 by touching, clicking, or otherwise selecting, a cursor icon or other control element. Alternatively, a clinician may first initiate a pause function prior to initiating the cursor mode, the pause function freezing the real-time display of graphical representations at a pause time. Thereafter, upon initiating cursor mode, the clinician may be provided with a scroll element, toggle wheel, or other control for scrolling backward or forward through a history of the graphical representations. As the clinician scrolls through the history, a specific historical time, or scroll time, may be displayed to the clinician in a highlighted field. Additionally, as the clinician operates the scroll feature, each graphical representation simultaneously scrolls backward or forward in time, in unison with the other displayed graphical representations, and coinciding with the historical time displayed in the highlighted, or selected, field. Further, a cursor, or any other suitable visual indicator, may be simultaneously displayed on each curve, or other data rendering, of each graphical representation corresponding to the selected historical time. As such, each cursor indicates a data position on each graphical representation, e.g., on each waveform or loop, that coincides with the selected historical time such that a clinician may visualize corresponding respiratory data presented in each graphical representation. In addition to the cursor display, one or more reference lines may be displayed on each graphical representation. The one or more reference lines may each intersect a cursor and an axis of a graphical representation. For instance, reference lines may intersect a horizontal or a vertical axis on a two-dimensional graphic representation or an x, y, or z axis on a three-dimensional graphic representation. Another field may be provided at the intersection of each axis, highlighting specific respiratory data that corresponds to coordinates on each graphical representation at the selected historical time.

For example, as the clinician scrolls backward or forward through historical data, a plurality of historical PV loops may be generated in sequential order depicting various historical breaths. Although a PV loop does not directly display a temporal element or axis, embodiments may display a cursor on the PV loop that corresponds to the historical time displayed in the highlighted, or selected, field. Specifically, the ventilator may determine, by evaluating the underlying data of the PV loop, or otherwise, a temporal element associated with each limb of the PV loop, i.e., the inspiratory and expiratory phases of each respiratory cycle. As such, when the clinician scrolls back in time, for example to a specific historical time during a first inspiratory phase of a third respiratory cycle, a graphics module 226 may determine that a third PV loop, representing the third breath or respiratory cycle, should be generated. Graphics module 226 may further determine the specific position on the inspiratory curve of the third PV loop that coincides with the selected historical time and may display a cursor in that position. Note that for a PV loop, the ventilator must both determine an appropriate breath associated with a selected historical time, such that the appropriate PV loop is displayed, and determine an appropriate position along the appropriate PV loop corresponding to the selected historical time. An appropriate flow-volume loop may be similarly generated and a cursor similarly displayed in an appropriate position corresponding to a selected historical time.

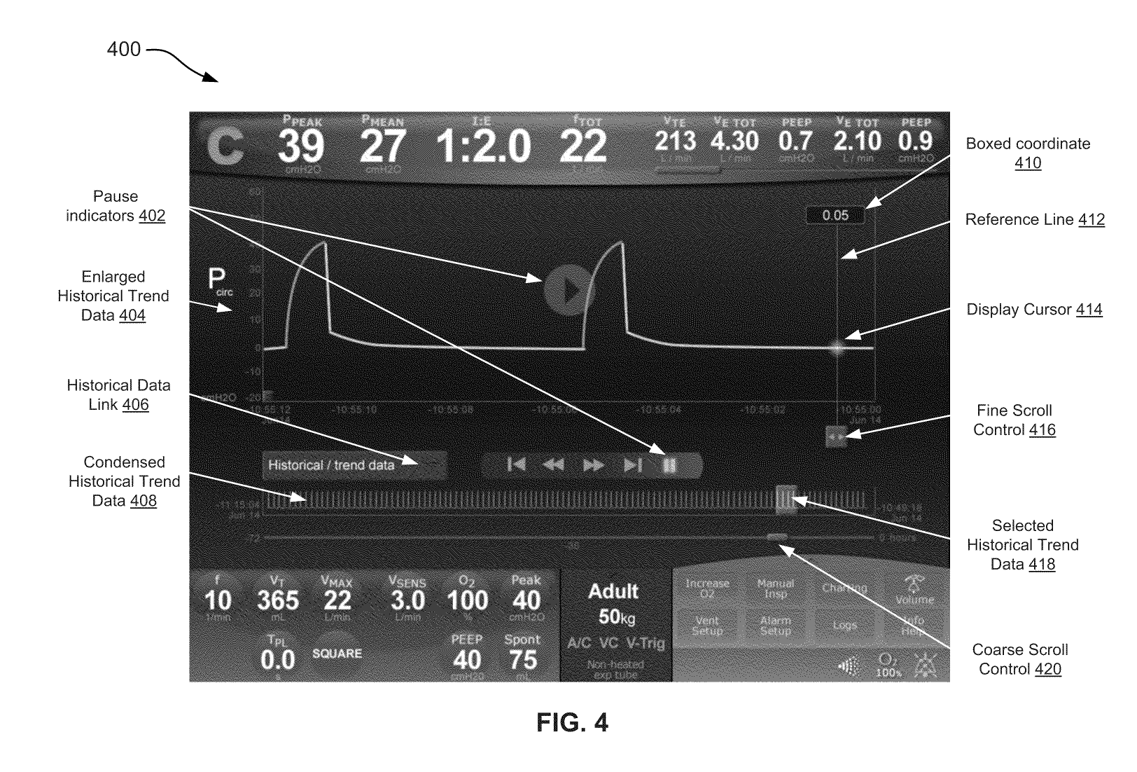

According to other embodiments, as illustrated in FIG. 4, display module 204 may be configured to present only a single graphical representation to the user. Indeed, as described previously with reference to the display module 204 and the user interface 210, the clinician may be able to access a single graphical representation by selecting any one of the plurality of graphical representations, as described with reference to FIG. 3. For example, the clinician may select a single graphical representation from another display screen by touching, clicking, or otherwise selecting the single graphical representation. The single graphical representation may then be enlarged for optimal visualization by the clinician. Cursor mode may also be initiated while visualizing a single graphical representation, as described above. In this case, a clinician may scroll through the history of the single graphical representation and may enlarge a portion of a waveform, for instance. A cursor may be displayed, as described above, corresponding to a selected historical time. Further, as described above, one or more reference lines may be provided to the clinician that may each intersect the cursor and an axis of the single graphical representation. As above, the one or more reference lines may be useful for identifying particular data points on the axis of the single graphical representation that correspond to the selected historical time.

Monitoring modules 216-222 may operate to monitor the physical condition of the patient in conjunction with the proper operation of the ventilator 202. Although only a sampling of potential monitoring modules are shown and described, any number of suitable monitoring modules may be provided in keeping within the spirit of the present disclosure. The monitoring modules 216-222 may communicate with display module 204, user interface 210, graphics module 226, or other suitable modules or processors of the ventilator 202. Specifically, monitoring modules 216-222 may communicate with graphics module 226 and/or display module 204 such that collected data regarding the physical condition of the patient and/or the prescribed ventilation may be displayed to the clinician.

Monitoring modules 216-222 may utilize one or more sensors to detect changes in various physiological parameters. Specifically, the one or more sensors may be placed in any suitable internal location, within the ventilator itself, or in any suitable external location, within the ventilatory circuitry or other devices communicatively coupled to the ventilator 202. For example, sensors may be coupled to inspiratory and/or expiratory modules for detecting changes in, for example, circuit pressure and flow. Additionally, the one or more sensors may be affixed to the ventilatory tubing or may be imbedded in the tubing itself.

Specifically, fractional inspired oxygen (FiO₂) monitor module 216 may monitor and control FiO₂. FiO₂ is a measure of the fraction of oxygen in a gaseous mixture delivered to the patient. FiO₂ settings may be configured according to safety guidelines as determined by the manufacturer, by an applicable protocol, or by the clinician. FiO₂ monitor module 216 may determine FiO₂ based on readings from various sensors or other techniques, such as by pulse oximetery (SpO₂).

Pressure monitor module 218 may monitor pressure within a ventilatory circuit. The pressure monitor module 218 may measure pressure according to any suitable method either known are discovered in the future. For example, pressure transducers may be attached at various locations along the ventilatory circuit to detect changes in circuit pressure. Specifically, sensors may utilize optical or ultrasound techniques for measuring changes in circuit pressure. Alternatively, pressure monitor module 218 may derive pressure readings from other data and measurements according to mathematical operations or otherwise.

Flow monitor module 220 may monitor airflow within a ventilatory circuit, for example by utilizing sensors as described above for monitoring pressure. Inspiratory flow may be represented as a positive flow and expiratory flow may be represented as a negative flow. Flow may be measured or derived by any suitable method either currently known or disclosed in the future. Specifically, flow may be derived according to mathematical operations or measured at selected points along the ventilatory circuit.

Volume monitor module 222 may monitor the volume of air exchanged during a respiratory cycle. Volume monitor module 222 may measure tidal volume by any suitable method, or may derive volume according to mathematical equations based on measurements of pressure and/or flow, for example.

Display module 204 may be further configured to communicate with graphics module 226. Graphics module 226 may interact with the various monitoring modules 216-222 and may process data received from monitoring modules 216-222 and time module 224 to produce the various graphical representations displayed on display module 204. Alternatively, graphics module 226 may be configured with a clock for monitoring time without need for an additional time module 224. Graphics module 226 may be configured to process data according to any suitable mathematical or graphical means. For instance, graphics module 226 may plot raw data received from one monitoring module versus raw data received from another monitoring module. Alternatively, graphics module 226 may transform raw data received from one or more monitoring modules by utilizing one or more mathematical operations, and may plot the mathematically transformed data versus other raw data, versus other transformed data, or versus a unit of time, for example. Indeed, graphics module 226 may transform raw data and may plot transformed or raw data to produce any number of useful graphical representations as may be desired by the clinician. Graphics module 226 may receive commands from user interface 210 or may be preconfigured to perform certain default operations and manipulations of data for generating useful graphical representations. Graphics module 226 may further be configured to continuously accept data from the various monitoring modules 216-222 and from the user interface 210 such that the graphical representations displayed on display module 204 may be continuously updated and presented in real-time to the clinician.

Additionally, graphics module 226 may be configured to store historical data associated with each graphical representation. Graphics module 226 may be in communication with time monitor module 224, or other clock feature provided by the ventilator 202, such that data within each graphical representation is associated with a time stamp. Specifically, underlying respiratory data may be time-stamped as it is received from the monitoring modules 216-222. As graphical representations of the respiratory data are generated by graphics module 226, a time element may be incorporated such that each position on a waveform or loop, for instance, is associated with a time element. Graphics module 226 may archive time-stamped historical data in sequential order over a particular time period. Thereafter, a clinician may utilize a scroll feature, as described above, to scroll through a history of graphical representations stored over the time period. The time period may represent any temporal period of interest to the clinician, for instance, an hour, a day, a week, or an entire treatment period. Indeed, the ventilator may archive all data during a respiratory treatment period unless the clinician instructs otherwise. In the alternative, the ventilator may archive data over a most recent period, perhaps the last day, in order to free memory for other ventilatory functions.

In an embodiment, as a clinician utilizes the scroll feature, graphics module 226 may drill into the underlying historical data to determine an associated time element, or may retrieve a time element associated with each stored graphical representation, in order to provide an appropriate graphical representation to the clinician based on a selected historical time. For example, graphics module 226 may determine an appropriate historical PV loop and an appropriate position on the appropriate PV loop associated with a selected historical time. Graphics module 226 may display a cursor at the appropriate position on the appropriate PV loop. Graphics module 226 may also be configured to simultaneously display cursors in corresponding locations on any other displayed graphical representations based on the selected historical time. As described above, reference lines intersecting the cursors and the axes of the various graphical representations may also be provided, along with a plurality of boxed fields for highlighting specific respiratory data associated with the selected historical time.

FIG. 3 is an illustration of art embodiment of a graphical user interface for displaying a plurality of historical graphical representations of respiratory data. Specifically, FIG. 3 illustrates an embodiment of a Cursor Display Screen 300 wherein a clinician may initiate a cursor mode and thereafter may simultaneously view a plurality of historical graphical representations corresponding to a selected historical time, or scroll time.

The disclosed embodiment of the Cursor Display Screen 300 provides a plurality of graphical representations of respiratory data to a clinician. Graphical representations may include, inter cilia, pressure and volume waves, flow curves, pressure-volume loops, and flow-volume loops. Specifically, the Cursor Display Screen 300 includes, for example, a pressure waveform (graphical representation 302), a flow waveform (graphical representation 304), a volume waveform (graphical representation 308), a flow-volume loop (FV loop) (graphical representation 31.4), and a pressure-volume loop (PV loop) (graphical representation 316).

Pressure waveform 302 may display circuit pressure in cm H₂O over time (for example, over seconds, s). As shown, pressure waveform 302 illustrates two distinct peaks in circuit pressure, corresponding to the inspiratory phases of two respiratory cycles, or breaths. Flow waveform 304 may display flow in liters per minute (Lpm) over time (for example, over seconds, s). As shown, flow waveform 304 illustrates inspiratory flow as a positive curve, and expiratory flow as a negative curve. Two distinct respiratory cycles or breaths, each including a positive inspiratory phase and a negative expiratory phase, are illustrated in flow waveform 304. Volume waveform 308 may display the total volume, or tidal volume, of gas inhaled and exhaled during each respiratory cycle over time. For example, volume waveform 308 displays the volume in milliliters (mL) over time in seconds, s. As shown, volume waveform 308 illustrates two distinct peaks, corresponding to two respiratory cycles, or breaths.

FV loop 314 displays flow in Lpm versus volume in mL for a single breath. Note that FV loop 314 does not display a unit of time. Further, note that FV loop 314 displays only one respiratory cycle, while graphs 302, 304, and 308 each display two respiratory cycles. As indicated by the exemplary display of cursors, FV loop 314 illustrates a breath corresponding to the second breath illustrated in graphs 302, 304, and 308. PV loop 316 displays volume in mL versus pressure in cm H₂0 for a single breath. Again, note that the PV loop 316 displays only a single breath and lacks any reference to time. As shown, the PV loop 316 also displays a single breath, corresponding to the second breath illustrated in graphs 302, 304, and 308.

The disclosed windows and elements Cursor Display Screen 300 may be arranged in any suitable order or configuration such that information may be communicated to the clinician in an efficient and orderly manner. Windows disclosed in the illustrated embodiment of the Cursor Display Screen 300 may be configured with elements for accessing alternative graphical display screens as may be provided by the ventilator. Disclosed windows and elements are not to be understood as an exclusive array, as any number of similar suitable windows and elements may be displayed for the clinician within the spirit of the present disclosure. Further, the disclosed windows and elements are not to be understood as a necessary array, as any number of the disclosed windows and elements may be appropriately replaced by other suitable windows and elements without departing from the spirit of the present disclosure. The illustrated embodiment of the Cursor Display Screen 300 is provided as an example only, including potentially useful windows and elements that may be provided to the clinician to facilitate the input of selections and commands relevant to the display of respiratory data and to display such respiratory data in an orderly and informative way, as described herein.

Further embodiments of the Cursor Display Screen 300 may include, for example, various display elements, including displayed cursors, reference lines, and boxed coordinates, and various control elements, including elements for selecting or initiating various functionalities including cursor mode. Specifically, Cursor Display Screen 300 may provide reference lines 306 for assisting a clinician in identifying specific respiratory data associated with a selected historical time. As described above, reference lines 306 may intersect a cursor displayed along a waveform or loop, for instance, and may also intersect an axis of the graphical representation. Thus, reference lines 306 identify respiratory data on an axis of a graphical representation that corresponds to a position on the graphical representation at the selected historical time.

As previously described, a display cursor 310 may be provided along a waveform or loop, for instance, to designate a position on the waveform or loop corresponding to a selected historical time. Display cursor 310 is depicted as a highlighted region in FIG. 3, but display cursors may be presented in any shape or form such that a position on a waveform, loop, or other graphical representation may be identified for a clinician. Display cursors 310 may be further displayed on each graphical representation (as shown) such that a clinician may easily compare respiratory data from multiple graphical representations at one time. Additionally or alternatively, display cursors 310 may be displayed upon initiation of cursor mode such that as a clinician scrolls backward and forward through historical data, display cursors may simultaneously move along appropriate waveforms and loops corresponding to a scroll time. When a clinician stops scrolling, display cursors may stop moving, and a scroll time identified when the scrolling stops may become the selected historical time, for example.

In addition, boxed coordinates 312 may be highlighted, or otherwise presented for optimal viewing and comparison. For example, boxed coordinates 312 may be presented in a field or element that creates a box, or other shape or form, around appropriate respiratory data, as shown. In particular, boxed coordinates 312 may display specific respiratory data associated with a position on each graphical representation at the selected historical time or scroll time. For example, a single boxed coordinate 312 may be displayed where a reference line 306 intersects an axis of a graphical representation, as shown. Indeed, boxed coordinates 312 may be displayed at each intersection of each axis of each graphical representation for optimal viewing and comparison of respiratory data corresponding to the selected historical time. As described above, boxed coordinates 312 may be displayed upon initiation of cursor mode such that as a clinician scrolls backward and forward through historical data, boxed coordinates 312 may be simultaneously updated and presented. In this case, when a clinician stops scrolling, updated boxed coordinates 312 may be presented that correspond to the historical time when scrolling stopped.

As described previously with reference to graphics module 226, respiratory data may be time-stamped, or otherwise associated with a time element, when respiratory data is received by monitoring modules 216-222. Alternatively, a time element may be associated with the respirator data when a graphical representation is generated by the graphics module 226, for example. In either case, when a clinician utilizes cursor mode to scroll back into historical data, graphics module 226, or other retrieval module (not shown), may determine appropriate respiratory data corresponding to the scroll time. The appropriate respiratory data may then be displayed as boxed coordinates 312.

Pause control 318 may be provided both as a visual display indicating that the display module 204 is in a pause mode and as a control element for activating and deactivating the pause mode. Pause control 318 may be activated by touching, clicking, or otherwise selecting the pause control 318. As noted above, pause control 318 may be initiated prior to initiating cursor mode. Alternatively, initiating cursor mode may include placing the display module in a pause mode. Specifically, pause control 318 may freeze the plurality of graphical representations upon initiation. Thereafter, historical graphical representations may be accessed, as described below.

Historical time 320 may designate the point in history that is currently identified by display cursors 310. Historical time 320 may be highlighted or otherwise presented for optimal viewing. For example, historical time 320 may be presenting in a field or element that creates a box, or other shape or form, around the historical time. According to one embodiment, as a clinician scrolls back in history, historical time 320 may be continuously updated with the scroll time currently displayed. When a clinician stops scrolling, the updated scroll time may be presented as a selected historical time 320.

Cursor control 322 may be provided additionally or alternatively to pause control 318. When cursor control 322 is provided in addition to pause control 318, initiating pause control 318 may cause cursor control 322 to become highlighted such that cursor control 322 is available for selection. According to this embodiment, when pause control 318 has not been initiated, cursor control 322 may be grayed out, hidden, or otherwise unavailable for selection. In an alternative embodiment, pause control 318 and cursor control 322 may both be available for selection from Cursor Display Screen 300. However, in this embodiment, selection of pause control 318 may merely initiate pause mode, while selection of cursor control 322 may initiate both pause mode and cursor mode. In still another embodiment, pause control 318 may be absent, hidden, or otherwise unavailable for selection from Cursor Display Screen 300. According to this embodiment, as described above, cursor control 322 may initiate both pause mode and cursor mode.

As noted above, selection or activation of cursor control 322 may initiate a cursor mode. The cursor mode may be activated by touching, clicking, or otherwise selecting the cursor control 322. Specifically, the cursor mode enables a clinician to contemporaneously view and compare respiratory data corresponding to a common historical point in time displayed in a variety of historical graphical representations. As previously described, when cursor mode is initiated, display cursors and reference lines may be automatically displayed. For example, upon initiating cursor mode, display cursors, for example display cursors 310, may be displayed in a position on each waveform or loop that corresponds to the cursor initiation time. In addition, as described above, the cursor initiation time may be represented in the historical time 320 field. Reference lines, for example reference lines 306, may be displayed intersecting the display cursors and the axes of the various graphical representations corresponding to the cursor initiation time. In addition, respiratory data, for example boxed coordinates 312, may be presented in boxed fields and may identify specific respiratory data corresponding to the cursor initiation time on each of the various graphical representations.

Additionally, when cursor mode is initiated, a scroll feature for viewing historical graphic representations may be provided. The scroll feature may be provided as a scroll bar, scroll wheel, toggle switch, or other mode of control. Specifically, the scroll feature enables a clinician to scroll backward or forward through historical graphical representations. According to one embodiment, as the clinician scrolls through the history, display cursors, reference lines, and a historical time field are automatically updated. For instance, as the clinician scrolls through the history, a scroll time may be associated with the scrolling and the scroll time may continuously populate the historical time field during scrolling. In addition, display cursors 310 and reference lines 306 may simultaneously move along a waveform, for example, as the historical time 320 field is updated. When the clinician stops scrolling, the scroll time may populate the historical time 320 field, as described above, and may also be referred to as the selected historical time. In addition, an appropriate loop may be displayed, for example, which corresponds to a breath associated with the time represented in the historical time 320 field. Indeed, appropriate loops may be continuously redrawn as the clinician scrolls through the history such that displayed loops correspond to the time represented in the historical time 320 field. Boxed coordinate 312 may be continuously updated such that boxed coordinates 312 reflect the specific data on each graphical representation corresponding to the time represented in the historical time 320 field.

At any suitable point, a clinician may discontinue scrolling. At that point, display cursors 310 and reference lines 306 may stop moving along the waveform or appropriate loop and boxed coordinates 312 may be updated to reflect the specific data on each graphical representation corresponding to the selected historical time, i.e., the time represented in the historical time 320 field when scrolling stopped. At that point, the clinician may optimally view and compare corresponding respiratory data from a variety of graphical representations. Additionally, the clinician may begin scrolling again, stopping and starting, scrolling backward and forward, as desired.

When the clinician has finished viewing the historical data, the client may deactivate cursor mode by touching, clicking, or otherwise selecting the cursor control 322. In addition, the clinician may deactivate the pause mode by touching, clicking, or otherwise selecting the pause control 318. Upon deactivating the cursor mode and the pause mode, graphical representations may be displayed on display module 204 in real-time. Although real-time graphic display may not be presented during pause and/or cursor mode, the respiratory data may still be collected by the monitoring modules 216-222 and archived by the graphics module 226 such that the clinician may subsequently view this respiratory data in one or more other cursor mode sessions.

FIG. 4 is an illustration of an embodiment of a graphical user interface for displaying historical graphical representations for a single type of respiratory data. Specifically, FIG. 4 illustrates an embodiment of a Historical Display Screen 400 wherein a clinician may scroll through and view historical trend data for a single graphical representation.

Historical Display Screen 400 may display a history of a single graphical representation of respiratory data. For example, as illustrated in FIG. 4, a history of a pressure waveform for a particular patient may be presented. Historical Display Screen 400 may be accessed via a hyperlink, or other link, from any other suitable display or input screen. For instance, Historical Display Screen 400 may be accessed from a display screen presenting multiple real-time graphical representations of respiratory data, for example, a real-time pressure waveform. According to another embodiment, Historical Display Screen 400 may be accessed from a main history screen providing access to any number of historical display screens. For instance, the main history screen may provide options for selecting historical graphical representations of a volume waveform, pressure waveform, flow waveform, FV loop, PV loop, etc. According to still another embodiment, an enlarged display of a real-time graphical representation may be accessed, and within the enlarged real-time display, access to a Historical Display Screen 400 may be provided.

Depending on the means of accessing Historical Display Screen 400, a clinician may be provided with different options, controls, and elements for scrolling through and viewing historical data. For example, if the Historical Display Screen 400 is accessed directly, as by a hyperlink or via selection from a main history screen, the Historical Display Screen 400 may be presented to the clinician in a “paused” form, as described above with reference to pause mode. In the alternative, for example when the Historical Display Screen 400 is accessed from an enlarged display of a real-time graphical representation, a clinician may first initiate a pause mode of the real-time display of the respiratory data in order to view historical graphical representations. In another embodiment, real-time graphical representations may be automatically paused when a clinician begins scrolling through the historical data. In any case, with reference to FIG. 4, pause indicators 402 may be provided on the display screen to indicate to the clinician that real-time data is no longer being displayed. Further, an enlarged display of a selected historical graphical representation, as described below, may be provided as illustrated by enlarged historical trend data 404.

Historical Display Screen 400 may also provide a link, icon, tab, button, or other control element, for accessing a condensed display of historical data. For example, historical data link 406 may provide access to condensed historical trend data 408 by touching, clicking, or otherwise activating the historical data link 406. Condensed historical trend data 408 provides a miniaturized view of historical graphical representations for a particular type of respiratory data, for example circulatory pressure. A coarse scroll control 420 may be provided adjacent the condensed historical trend data 408. Coarse scroll control 420 may be provided above, below, or in any other suitable location adjacent the condensed historical trend data 408. Specifically, a clinician may touch, click, or otherwise activate coarse scroll control 420 such that a portion of the condensed historical trend data 408 is highlighted or selected. The selected portion, i.e., selected historical trend data 418, may be displayed in enlarged form as enlarged historical trend data 404. As such, a clinician may identify particular events, irregularities, or areas of interest, etc., in regions of the condensed historical trend data 408, and may then select and enlarge these irregular, or otherwise interesting, regions for more detailed review.

Various other displays and controls may be provided in conjunction with enlarged historical trend data 404. For example, a fine scroll control 416 for scrolling within the enlarged historical trend data 404 may be provided. Fine scroll control 416 may be activated by touching, clinking, or otherwise selecting the fine scroll control element 416. In addition, fine scroll control element 416 may enable a clinician to move forward and/or backward along a curve, loop, waveform, or other graphic representation corresponding to enlarged historical trend data 404. When fine scroll control element 416 has been activated, a cursor or other visual indicator may be presented, such as display cursor 414. Display cursor 414 may identify a position on enlarged historical trend data 404 corresponding to a specific placement of the fine scroll control element 416. Thus, as the clinician scrolls backward and/or forward along enlarged historical trend data 404, display cursor 414 may provide visual indicia along the curve, loop, or waveform that tracks fine scroll control element 416. In addition, as described above, a reference line 412 may be provided that intersects an axis of enlarged historical trend data 404 and display cursor 414. Reference line 412 may be provided such that a clinician may easily identify respiratory data on the axis of enlarged historical trend data 404 while adjusting fine scroll control element 416. Further still, boxed coordinate 410 may be provided such that the respiratory data corresponding to the position on enlarged historical trend data 404 may be highlighted, enlarged, or otherwise conveniently presented to the clinician. As described above with reference to FIG. 3, as the clinician scrolls along enlarged historical trend data 404, display cursor 414 and reference line 412 simultaneously and synchronously track the scrolling along the curve, loop, or waveform. As scrolling continues, boxed coordinate 410 may be continuously updated to reflect respiratory data corresponding to a current scroll position along the curve, loop, or waveform.

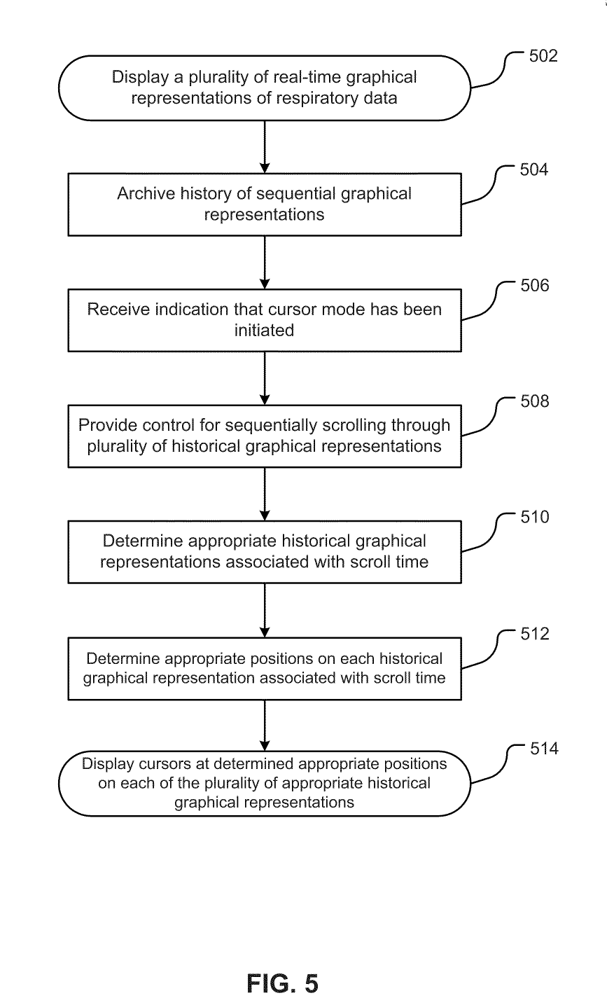

FIG. 5 is a flow chart illustrating an embodiment of a method for displaying cursors in appropriate positions on a plurality of historical graphical representations of respiratory data.

At real-time display operation 502, the ventilator may present a plurality of graphical representations of respiratory data in real-time to a clinician. As described above, a ventilator may provide numerous graphical representations of respiratory data to a clinician during respiration of a patient. Specifically, as described above, monitoring modules 216-222 may communicate with graphics module 226 and/or display module 204 such that collected data regarding the physical condition of the patient may be displayed to the clinician in real-time. Indeed, data may be collected and displayed according to any suitable method.

At archive operation 504, the ventilator may store a sequential history of the graphical representations provided according to real-time display operation 502. As described above, graphics module 226, or another suitable component or module, may archive graphical representations according to time. Some graphical representations may inherently include a time element, as with waveforms of respiratory data presented over time. Other graphical representations may be presented as a function of a single respiratory cycle, or breath, such as a FV or a PV loop. Graphics module 226, or another suitable component or module, may associate the respiratory data of the graphical representation with a time element. In the alternative, monitoring modules 216-222 may associate the real-time respiratory data with a time element, or time stamp, before communicating data to graphics module 226. In either case, graphical representations are archived in sequential order based on time.

At cursor mode operation 506, the ventilator may receive an indication that cursor mode has been activated. As described above, cursor mode may be activated by any suitable means and may be activated in combination with a pause mode.

A scroll operation 508, the ventilator may provide a control for scrolling through the history of sequential graphical representations. As described above, the scrolling feature may be provided by any suitable control wheel, scroll bar, arrow keys, toggle control, etc., such that a clinician is able to scroll backward and forward through the historical data.

At determine operation 510, appropriate graphical representations corresponding to a point in time associated with the scrolling feature, or scroll time. As described above, although not all historical graphical representations may be presented over time, a time element may be associated with the data represented in each historical graphical representation. Thus, an appropriate loop may be displayed, for example, which corresponds to a breath associated with the scroll time. Indeed, appropriate loops may be continuously redrawn as the clinician scrolls through the history such that displayed loops correspond to the scroll time.

At determine position operation 512, an appropriate position on each appropriate graphical representation corresponding to the scroll time may be determined. As described above, respiratory data represented in each graphical representation may be associated with a time element. As such, a position on each curve, waveform, loop, etc., which corresponds to the scroll time may be determined.

At display operation 514, cursors may be displayed that identify the determined position on each graphical representation corresponding to the scroll time. Thus, the clinician may optimally view and compare the various appropriate graphical representations based on a particular historical time, or scroll time.

The above-mentioned embodiments of one or more cursor display screens, illustrated in FIGS. 4 and 5, are not meant to provide an exclusive array of potential or possible embodiments. Indeed, some of the features and characteristics of the above embodiments may be interchanged and combined to provide additional embodiments and configurations of the described graphical user interfaces. In addition, in keeping with the spirit of the present disclosure, features described may not be essential, but may be added or removed according to the desires and needs of a clinician, hospital, clinic, or other entity or individual.

It will be clear that the systems and methods described herein are well adapted to attain the ends and advantages mentioned as well as those inherent therein. Those skilled in the art will recognize that the methods and systems within this specification may be implemented in many manners and as such is not to be limited by the foregoing exemplified embodiments and examples. In other words, functional elements being performed by a single or multiple components, in various combinations of hardware and software, and individual functions can be distributed among software applications at either the client or server level. In this regard, any number of the features of the different embodiments described herein may be combined into one single embodiment and alternative embodiments having fewer than or more than all of the features herein described are possible.

While various embodiments have been described for purposes of this disclosure, various changes and modifications may be made which are well within the scope of the present invention. Numerous other changes may be made which will readily suggest themselves to those skilled in the art and which are encompassed in the spirit of the disclosure and as defined in the appended claims.

What is claimed is:

1. A method implemented by a ventilator for displaying respiratory data on a graphical user interface, the method comprising:
archiving a plurality of graphical representations of the respiratory data in sequential order during a time period;
receiving a selection of a historical time within the time period;
determining appropriate graphical representations of the archived plurality of graphical representations corresponding to the selected historical time; and
determining appropriate positions on the appropriate graphical representations corresponding to the selected historical time.

2. The method according to claim 1, further comprising:
displaying a visual indication at each appropriate position on each appropriate graphical representation corresponding to the selected historical time.

3. The method according to claim 2, wherein displaying the visual indication comprises displaying a cursor at each appropriate position on each appropriate graphical representation corresponding to the selected historical time.

4. The method according to claim 3, further comprising:
displaying one or more reference lines, wherein the one or more reference lines intersect the cursor and an axis of each appropriate graphical representation.

5. The method according to claim 3, further comprising:
displaying respiratory data associated with each appropriate position on each appropriate graphical representation corresponding to the selected historical time.

6. The method according to claim 1, wherein receiving a selection of the historical time further comprises:
providing a scrolling feature for scrolling through the archived plurality of graphical representations;
providing a scroll time that is continuously updated during scrolling, wherein the scroll time is associated with a sequential time during the time period; and
equating the scroll time with the selected historical time when scrolling stops.

7. The method according to claim 6, further comprising:
displaying a visual indication at each appropriate position on each appropriate graphical representation corresponding to the scroll time during scrolling.

8. A graphical user interface for displaying respiratory data, the ventilator configured with a computer having a user interface including the graphical user interface for accepting commands and for displaying respiratory data, the graphical user interface comprising:
at least one window associated with the graphical user interface;
one or more graphical representations of real-time respiratory data within the at least one window; and
one or more elements within the at least one window comprising at least a cursor element.

9. The graphical user interface of claim 8, wherein the one or more graphical representations of real-time respiratory data are sequentially archived over a time period to create one or more historical graphical representations.

10. The graphical user interface of claim 8, the one or more elements further comprising:
a pause element.

11. The graphical user interface of claim 10, wherein selection of the pause element initiates a pause mode that interrupts real-time display of the one or more graphical representations.

12. The graphical user interface of claim 9, wherein selection of the cursor element initiates a cursor mode that provides access to the one or more historical graphical representations.

13. The graphical user interface of claim 12, wherein the cursor mode further comprises:
receiving a selection of a historical time; and
displaying one or more visual indicators at positions on the historical graphical representations corresponding to the selected historical time.

14. The graphical user interface of claim 13, wherein receiving a selection of a historical time further comprises:
providing a scrolling feature for scrolling through the archived plurality of graphical representations;
providing a scroll time that is continuously updated during scrolling, wherein the scroll time is associated with a sequential time during the time period; and
equating the scroll time with the selected historical time when scrolling stops.

15. A ventilatory system for providing a graphical user interface for accepting commands and for displaying respiratory data, comprising:
at least one display device;
at least one processor; and
at least one memory, communicatively coupled to the at least one processor and containing instructions that, when executed by the at least one processor, provide a graphical user interface on the at least one display, comprising:
at least one window associated with the graphical user interface;
one or more graphical representations of real-time respiratory data within the at least one window; and
one or more elements within the at least one window comprising at least a cursor element.

16. The ventilatory system of claim 15, wherein the one or more graphical representations of real-time respiratory data are sequentially archived over a time period to create one or more historical graphical representations.

17. The ventilatory system of claim 16, wherein selection of the cursor element initiates a cursor mode that provides access to the one or more historical graphical representations.

18. The ventilatory system of claim 17, wherein the cursor mode further comprises:
receiving a selection of a historical time; and
displaying one or more visual indicators at positions on the historical graphical representations corresponding to the selected historical time.

19. The ventilatory system of claim 18, wherein receiving a selection of a historical time further comprises:
providing a scrolling feature for scrolling through the archived plurality of graphical representations;
providing a scroll time that is continuously updated during scrolling, wherein the scroll time is associated with a sequential time during the time period; and
equating the scroll time with the selected historical time when scrolling stops.

20. The ventilatory system of claim 18, wherein the cursor mode further comprises:
displaying one or more reference lines, wherein the one or more reference lines each intersect a visual indicator and an axis of a historical graphical representation corresponding to the selected historical time; and,
displaying respiratory data associated with the visual indicators on the historical graphical representations corresponding to the selected historical time.
